(19) United States
(12) Patent Application Publication
(10) Pub. No.: US 2006/0140995 A1
(43) Pub. Date: Jun. 29, 2006

(54) Methods for treating ectoparasite infections on the mammalian body

(76) Inventor: Michael J. Precopio, Collegeville, PA (US)

Correspondence Address: Henry E. Millson, Jr., 675 Golden Hawk Drive, Prescott, AZ, 86301-6623, US

(21) Appl. No.: 10/519,372

(22) Filed: Dec. 23, 2004

(51) Int. Cl. A01N 25/00; A01N 31/00

(52) U.S. Cl. 424/405; 514/724

(57) ABSTRACT

Methods for treating ectoparasites, their nymphs, and their egg infestations on animal skin and hair, wherein the compositions used in the methods contain at least one monohydric aralkyl alcohol in a quantity sufficient to provide pesticidal activity; the compositions are applied to the infected areas in a quantity sufficient to completely saturate both the hair and the skin in the infected areas with the composition; and the compositions can be readily washed out of the infected areas by rinsing with water.

### FIELD OF THE INVENTION

This invention relates to methods for treating ectoparasite infestations on mammalian bodies, particularly lice infestations in humans.

### BACKGROUND OF THE INVENTION

Current methods for the treatment of ectoparasite infestations on mammalian bodies typically utilize somewhat toxic insecticidal compositions which are available in both prescription and over-the-counter formulations. Such compositions generally include one or more of the active ingredients benzyl benzoate, pyrethrin, permitrin, and lindane. Dispensing formulations include lotions, creams, shampoos, cream rinses, and gels.

However, increasing numbers of ectoparasite infections, especially head lice, that are resistant to the above insecticides have been reported in medical literature.

Alternative insecticidal treatments such as the use of malathion, ivermectin, and a combination of trimethoprim and sulfamethazole have been tried, but usually only with mixed results.

Another approach that has been reported and which is at least partially effective is the use of a topical petrolatum-containing product, which suffocate the parasites when left on the head for a prolonged period of time. However, removal of the petrolatum from the head and hair has proven to be a difficult problem, often taking about ten days for complete removal.

Oil based occlusive treatments have been observed to significantly immobilize and coat the lice long enough for asphyxiation to occur. However, some adult lice survived even after an overnight treatment. Meinkin, T L, Burkhart C G, Burkhart C N, Ectoparasitic Disease in Dermatology: Reassessment of Scabies and Pediculosis, Advances in Dermatology, Chapter 3, pp 99, Mosby Inc. 1999.

Head lice have been on the increase in the recent past, in large part due to the fact that they have become more tolerant or resistant to conventional treatments. For this reason children are being over-treated with pesticide-containing products as well as other unconventional treatments in an effort to control this epidemic. Many parents and health professionals have turned to unproven and generally ineffective alternative products such as mayonnaise, olive oil, etc. Unfortunately, others have turned to very dangerous alternatives such as gasoline, kerosene or traumatizing measures such as head shaving.

It was recently discovered by the present inventor that ectoparasites on animal skin can be treated successfully by a method comprising the steps of:
I) applying to the skin affected by ectoparasites a water-soluble or water-dispersible substantially air-impermeable liquid barrier composition;
II) leaving the composition in contact with the skin until the ectoparasites have been killed by suffocation; and
III) removing the composition and the dead ectoparsites from the skin, See, e.g. U.S. Pat. No. 6,793,931 B2; No. 5,858,383; and No. 6,139,859.

### SUMMARY OF THE INVENTION

Other than in the operating examples, or where otherwise indicated, all numbers expressing quantities of ingredients used herein are to be understood as modified in all instances by the term “about”.

It has now been discovered that water-soluble or water-dispersible compositions that contain at least one monohydric aralkyl alcohol have marked pesticidal activity against ectoparasites, e.g. lice, and in addition, are effective against ectoparasite nymphs and the ectoparasite eggs (called nits when the ectoparasites are lice), even when used in relatively low quantities in compositions containing them, and even with short contact times, provided that both the hair and the skin in the infected areas on mammals are completely saturated with the compositions.

### DETAILED DESCRIPTION OF THE INVENTION

The method of the invention for the topical treatment of ectoparasites, their nymphs and their eggs on mammalian skin and hair comprises the steps of
A) applying a water-soluble or water-dispersible, pharmacologically acceptable composition containing a pesticidally-active monohydric aralkyl alcohol to areas of mammal skin and hair infected with ectoparasites wherein
   a) the composition contains a quantity of the monohyric aralkyl alcohol sufficient to provide pesticidal activity against the ectoparasites,
   b) the composition is applied to the infected areas in a quantity sufficient to completely saturate both-the-hair and the skin in the infected areas, and
   c) the composition can be readily washed out of the infected areas by rinsing with water;

B) leaving the composition in contact with the skin and hair in the infected areas until at least most of the ectoparasites have been killed; and

C) removing the composition and the dead ectoparasites from the skin and hair by rinsing the skin and hair with water or other aqueous based liquid.

With respect to step A) a), the quantity of pesticidally active monohydric aralkyl alcohol sufficient to provide pesticidal activity against the ectoparasites is somewhat dependent on the particular ectoparasite being treated, but is usually in the range of from 1 to 50% by weight, preferably from 1 to 20% by weight, more preferably from 2 to 20% by weight, even more preferably from 2 to 9% by weight, more preferably yet from 3 to 7% by weight, and most preferably from 4 to 6% by weight, although from 1 to 4% by weight has also been found to be effective. The above percentages by weight are based on the total weight of the composition. Quantities greater than 50% by weight of the composition can also be used but are unnecessary and in addition may be difficult to formulate into pharmaceutically acceptable compositions.

The mammalian skin treated by the method of the present invention includes any skin area infected by an ectoparasite, especially those covered by hair, such as the human scalp and pubic area Household pets and other mammals e.g. agricultural and far animals can also be treated by the method of the invention

With respect to step A) b), it has now been discovered that it is necessary in order to obtain the maximum kill of both the ectoparasites, their nymphs, and their eggs to completely saturate both the hair and the surface of the skin in the areas infected with the ectoparasites. By the term “completely saturate” is meant that substantially all strands of hair are fully saturated with the composition along their entire length, and the skin in the infected area is also completely coated with the composition

The ectoparasites and their eggs treated by the method and compositions used in the practice of the invention include lice, especially head lice (Pediculus humanus capitis), as well as the crab (pubic) louse (phthirus pubis) and the body or clothing louse (Pediculus humanus humanus); as well as mites (chiggers, scabies and the like).

With respect to step A) c) the composition must be in a form that can be readily removed by washing or rinsing the composition with water.

Concerning step B), the composition is left in contact with the skin and hair until at least most of the ectoparasites have been killed. Such contact time is somewhat dependent on the particular ectoparasite being treated, but it has now been discovered that in general the contact time can be for a period of at least 2 minutes, preferably at least 3 minutes, and more preferably at least 5 minutes. Periods of from 2 to 10 minutes can be used, preferably from 3 to 10 minutes, e.g. from 3 to 8 or 9 minutes. It has now been found that contact times of greater than 9 or 10 minutes are unnecessary and do not provide any additional benefits, particularly where the composition is air-impermeable, although of course longer contact times can be used if desired.

Step C) is carried out by rinsing the skin and hair in the treated areas with water or other aqueous liquid. Other aqueous liquids are those containing mostly water but which also contain other components that enhance or at least do not prevent the rapid removal of the composition. When water rinse is used, step C) is preferably carried out for from 1 to 5 minutes e.g. from 1 to 3 minutes. Longer rinsing times can of course be used but are generally unnecessary.

The above method will kill most and usually all of the ectoparasites, especially lice, as well as most and usually all of the ectoparasite nymphs and ectoparasite eggs, and hence a repeat treatment is generally not necessary. However, if needed or desired the method of the invention can be repeated after an interval, e.g. after a 1 week to 3 week interval, to kill any remaining ectoparasites or nymphs that may have hatched from viable eggs.

When the ectoparasite is lice it has been discovered that when the compositions of the invention are in contact with the lice, the spiracles are prevented from closing, and when contact is for at least 2 minutes, the composition seems to remain inside the open spiracles and continues to suffocate the lice even after the composition has been rinsed from the skin and hair, i.e. still provides effective kill rates.

The effect occurs whether the lice that are still alive remain on the skin and hair or are removed when the composition is rinsed away in step C).

With respect to the compositions used in the practice of the invention in step A), the monohyric aralkyl alcohols are those in which the hydroxyl group is attached to an alkyl or alkenyl group. The aryl moiety is preferably phenyl or substituted phenyl group although other aryl groups such as those with multiple rings are also within the scope of the invention provided the resulting alcohol is effective and is pharmacologically compatible when applied to mammal skin and hair.

Preferred monohydric aralkyl alcohols of the invention are those having formula I below: 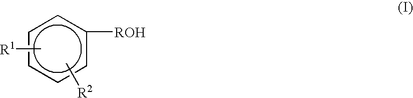
in which R is a C₁-C₁₂ straight or branched chain, saturated or olefinically unsaturated alkylene group, and R¹ and R² are independently hydrogen, halogen (fluorine, chlorine, bromine, or iodine), C₁-C₄, alkyl, or C₁-C₄ alkoxy groups. Preferred compounds of formula I are those in which the R group is a C₁-C₆ saturated alkylene group, especially those wherein R¹ and R² are both hydrogen. The most preferred compound of formula I is benzyl alcohol. When the R group is an ethylenically unsaturated alkylene group, this group can also be referred to as an alkenylene group.

It should be noted that other monohydric alcohols such as alkanols, e.g. ethanol and isopropyl alcohol, and polyhydric alcohols such glycols and polyalkyene glycols are not satisfactory for use in place of the monohyric aralkyl alcohols of formula I since they are either not effective or are not satisfactorily effective as pesticides and/or in preventing the respiratory system of the ectoparasites from closing within a reasonably short period of time, and in addition are generally not known to have any activity against ectoparasite eggs.

The compositions used in the practice of the invention can be air-impermeable compositions or substantially air-impermeable compositions. These compositions containing one or more monohydric aralkyl alcohols used in the practice of the invention include any such compositions that are compatible with the skin, i.e. those that contain no components that are toxic or carcinogenic to the skin or any other parts of the mammal if absorbed through the skin, including those that cause dermatitis, skin irritation, itching or the like.

By substantially air-impermeable is meant that the composition does not contain sufficient air nor does it permit air to penetrate the composition in a quantity that would prevent the composition from suffocating the ectoparasites. It is of course the lack of oxygen over a period of time that results in the suffocation of the ectoparasites. As discussed above, since the ectoparasites are killed by suffocation as well as pesticidal activity, they cannot become resistant to the air-impermeable compositions of the invention, unlike known compositions containing other pesticides.

The present compositions preferably do not contain any pesticides other than the aralkyl alcohol(s) since such additional pesticides are unnecessary and will most likely result in toxicity and other problems.

The present compositions used in the method of the invention have very low toxicity, i.e. are essentially nontoxic when applied to human and other animal skin and hair, especially those in which the monohydric alcohol is present in 30% by weight or less.

The compositions used in the practice of the invention are highly preferred to be air-impermeable, although as stated above they can be air-permeable or can contain air therein.

It is understood that the compositions described above most likely kill the ectoparasites by insecticidal activity alone where the compositions are not air-impermeable, or by a combination of suffocation and pesticidal, e.g. pediculicidal, activity of the aralkyl alcohols where the compositions are air-impermeable, and these are the only mechanisms of action. Hence, the compositions of the invention are accordingly free from toxic pediculicides and other toxic ingredients. At least some, and often all, of the ectoparasite eggs are also killed by the insecticidal activity of the aralkyl alcohols.

The composition of the invention can be in the form of a free-flowing liquid to a viscous liquid or in the form of a gel. Also included are lotions, creams, shampoos, cream rinses, and other water rinsible forms of the compositions.

The water-soluble or water-dispersible, substantially air impermeable liquid barrier compositions that contain monohydric aralkyl alcohols effectively prevent the ectoparasites from closing their respiratory systems (breathing apparatus), called breathing spiracles in lice, as well as acting as effective pesticides against both the ectoparasites and their eggs.

Ectoparasites such as lice, especially head lice, can normally defend against asphyxiation for prolonged periods of time, even up to 12 hours, by closing their spiracles. With the above air-impermeable compositions of the invention death occurs in very much shorter periods of time, e.g. in 9 or 10 minutes, and probably even much less, since the aralkyl alcohols prevent the ectoparasites from closing their breathing apparatus. This is much faster than expected since occlusion of the lice with other materials and compositions will take at least several hours to result in asphyxiation. As discussed above, it is believed that the above air-impermeable compositions of the invention function so rapidly by a combination of asphyxiation and pesticidal activity, resulting in a complete kill of the ectoparasites within such short periods of time. In addition, the monohydric aralkyl alcohols, especially benzyl alcohol, are bacteriostatic.

As discussed above, an important advantage of using air-impermeable compositions of the invention is that the ectoparasites, e.g. lice, even if they were to become resistant to the pesticidal activity of the monohydric aralkyl alcohol, cannot become resistant to asphyxiation, and asphyxiation can provide a rapid kill rate of greater than 99%, usually 100%.

It has also been discovered that when step C) is a relatively short contact time, e.g. from 2 minutes to 9 or 10 minutes, it is preferred to have the quantity of the formula I) compound(s) at least 5% by weight of the composition.

It was also discovered that to provide a kill rate of the ectoparasites of 99% or more when the concentration of the formula I) compound(s) is 5% or less in the present compositions, two spaced treatments may be needed, e.g. the method of the invention is carried out once, and then a second time after a time period of from 1 to 3 weeks has elapsed.

The compositions of the invention include at least one other component, i.e. compositions comprising component i) below and at least one of components ii) through v):
i) at least one monohydric aralkyl alcohol;
ii) a film forming agent;
iii) a surface active agent;
iv) a gelling or thickening agent;
v) water.

For example, a composition comprising component i) plus all of components ii) through v) in the form of a gel is one preferred air-impermeable composition of the invention.

Other optional components can include (but are not limited to) the following:
vi) a neutralizing agent; and
vii) a preservative.

The air-permeable or air-containing compositions of the invention can also contain one or more of the above components.

Component ii) when present is present in from 1 to 25% by weight, preferably from 2 to 10% by weight, more preferably from 3 to 7% by weight, and most preferably from 4 to 6% by weight.

Component iii) when present is present in from 0.1 to 10% by weight, preferably from 0.5% to 7% by weight, more preferably from 0.5 to 6% by weight, and most preferably from 0.8 to 5% by weight.

Component iv) when present is present in from 0.05 to 5% by weight, preferably from 0.1 to 3% by weight, more preferably from 0.15 to 1% by weight, and most preferably from 0.2 to 0.35% by weight.

The remainder is generally component v) (water), optionally with small quantities of a neutralizing agent to adjust the pH to neutral or close to neutral, and/or other optional components such as small quantities (e.g. 0.01 to 1% by weight) of one or more preservatives.

The film forming agents of component ii) include one or more of mineral oil (liquid petroleum) and other oils such as vegetable oils, e.g. cottonseed, coconut, palm, and the like, and other pharmacologically compatible oils such as other refined aliphatic petroleum oils, animal oils, e.g. fish oils, oleic acid, sperm oil, and oils derived from fruits and seeds such corn, olive, soybean, cottonseed, safflower, and the like. Mineral oil is preferred.

The surface active agent of component iii) is preferably one or more nonionic polysorbate surfactants (polyoxethylene fatty acid esters), obtained by the esterification of sorbitol with one or three molecules of a fatty acid, usually stearic, lauric, oleic, or palmitic acid, under conditions which cause splitting out of water from the sorbitol, leaving sorbitan fatty acid esters, i.e. a mixture of esters of the fatty acid with sorbitol and its mono- and di-anhydrides, and having a water content below 0.2. %. The above ester mixture is then condensed with varying quantities of ethylene oxide, usually about 20 moles of ethylene oxide per mole of sorbitol. Examples of such polysorbate surfactants include, but are not limited to, Polysorbate 20 (polyoxyethylene (20) sorbitan mono laurate), Polysorbate 60 (polyoxethylene (20) sorbitan mono stearate), Polysorbate 80 (polyoxyethylene (20) sorbitan monooleate), Polysorbate 65 (polyoxyethylene (20) sorbitan tristearate), and Polysorbate 85 (polyoxyethylene (20) sorbitan trioleate).

In addition to the above polysorbate surfactants, surfactant sorbitan esters can also be used, either alone or in combination with a polysorbate. Sorbitan ester surfactants include sorbitan mono esters with a fatty acid, preferably stearic, lauric, oleic, or palmitic acid

For use herein, it is preferred to use a mixture of polysorbate 80 an sorbitan monooleate, especially in a 50:50 or 60:40 weigh ratio.

The surface active agent of component iii) can also be one or more sugar-based surfactants, e.g. alkyl polyglycosides and glucosamides such as glucosamine and related compounds. The alkyl polyglycosides have the formula II below:
R₁O(R₂O)_{b}(Z)ₐ (II)
wherein R₁ is a monovalent organic radical having from about 6 to about 30 carbon atoms, preferably from 6 to 12 carbon atoms, and more preferably having an average of from 10 to 10.5 carbon atoms; R₂ is a divalent alkylene radical having from 2 to 4 carbon atoms; Z is saccharide residue having 5 or 6 carbon atoms; b is a number having a value from 0 to about 12; a is a number having a value from 1 to about 6, preferably from 1.2 to 2.2, and more preferably from 1.5 to 1.7. Preferred alkyl polyglycosides which can be used in the compositions according to the invention have the formula II wherein Z is or includes a glucose residue. Such alkyl polyglycosides are commercially available, for example; as TRITON® GC-110, an oligmeric D-glucopyranose decyl octyl glycoside from Union Carbide Corporation, and APG®, GLUCOPON®, or PLANTAREN® surfactants from Cognis Corporation, Ambler, Pa. 19002. Examples of the Cognis sues include but are not limited to:
1. GLUCOPON® 225DK Surfactant—an alkyl polyglycoside in which the alkyl group contains 8 to 10 carbon atoms and having an average degree of polymerization of 1.7.
2. GLUCOPON® 425N Surfactant—an alkyl polyglycoside in which the alkyl group contains 8 to 16 carbon atoms, having an average of 10.3 carbon atoms, and having an average degree of polymerization of 1.5.
3. GLUCOPON® 625UP Surfactant—an alkyl polyglycoside in which the alkyl group contains 12 to 16 carbon atoms and having an average degree of polymerization of 1.6
4. APG® 325N Surfactant—an alkyl polyglycoside in which the alkyl group contains 9-11 carbon atoms and having an average degree of polymerization of 1.5.
5. GLUCOPON® 600UP Surfactant—an alkyl polyglycoside in which the alkyl group contains 12 to 16 carbon atoms and having an average degree of polymerization of 1.4.
6. PLANTAREN® 2000 Surfactant—a C₈-C₁₆ alkyl polyglycoside in which the alkyl group contains 8 to 16 carbon atoms and having an average degree of polymerization of 1.5.
7. PLANTAREN® 1300 Surfactant—a C₁₂-C₁₆ alkyl polyglycoside in which the alkyl group contains 12 to 16 carbon atoms and having an average degree of polymerization of 1.6.
8. GLUCOPON® 220N Surfactant—an alkyl polyglycoside in which the alkyl group contains 8 to 10 carbon atoms and having an average degree of polymerization of 1.5.

Other examples of alkyl polyglycosides that can be used herein include alkyl polyglycoside surfactants which are comprised of mixtures of compounds of Formula II wherein Z represents a moiety derived from a reducing saccharide containing 5 or 6 carbon atoms; a is a number having a value from 1 to about 6; b is zero; and R¹ is an alkyl radical having from 8 to 20 carbon atoms. The compositions are characterized in that they have increased surfactant properties and an HLB in the range of about 10 to about 16 and a non-Flory distribution of glycosides, which is comprised of a mixture of an alkyl monoglycoside and a mixture of alkyl polyglycosides having varying degrees of polymerization of 2 and higher in progressively decreasing amounts, in which the amount by weight of polyglycoside having a degree of polymerization of 2 or mixtures thereof with the polyglycoside having a degree of polymerization of 3 predominate in relation to the amount of monoglycoside, said composition having an average degree of polymerization of about 1.8 to about 3. Such compositions, also known as peaked alkyl polyglycosides, can be prepared by separation of the monoglycoside from the original reaction mixture of alkyl monoglycoside and alkyl polyglycoside after removal of the alcohol. This separation may be carried out by molecular distillation and normally results in the removal of about 70 to 95% by weight of the alkyl monoglycosides. After removal of the alkyl monoglycosides, the relative distribution of the various components, mono- and poly-glycosides, in the resulting product changes and the concentration in the product of the polyglycosides relative to the monoglycoside increases as well as the concentration of individual polyglycosides to the total, i.e. DP2 and DP3 fractions in relation to the sum of all DP fractions. Such compositions are disclosed in U.S. Pat. No. 5,266,690, the entire contents of which are incorporated herein by reference.

In addition to the surfactants disclosed above, other surface active agents can also be used, either in place of; or in addition to, the above described surfactants. Examples of such other surfactants are disclosed in U.S. Pat. No. 6,139,859, which is expressly incorporated herein by reference.

The thickening agents of component iv) include polyacrylic acid polymers, available from B.F. Goodrich Chemical Corporation as CARBOPOL® polymers. CARBOPOL® 940 (Carbomer 940) is a water-soluble polyacrylic acid polymer which acts as a thickener and gel-former, CARBOPOL® 934P (Carbomer 934P) is preferred for use herein, which is an essentially benzene-free version of CARBOPOL® 940.

Other thickening agents that can be used include, but are not limited to, sodium carboxymethyl-cellulose, ethoxylated cellulose, hydroxy-propylcellulose, hydroxyethyl cellulose, glyceryl monostearate, hydroxyethyl stearyl amide, ethylene glycol monostearate, stearic diethanolamide, coconut fatty acid diethanolamide, lauric diethanolamide, lauric/myristic diethanolamide, guar hydroxypropyl trimonium chloride, ethylene glycol distearate, n-octadecanol, lauric monoisopropanolamide, isostearamido-propyl betaine, PEG (400-1000) mono- or di-stearates, glycerol dioleate, alkali metal alginates, xanthan gum, and the like.

Component vi) can be a pharmacologically compatible base, such as sodium or potassium carbonate, or an amine such as triethanolamine or an acidic component such as sodium bisulfate.

The component vii) preservatives can be used if needed. However, when component i) is benzyl alcohol, the benzyl alcohol also acts as a preservative. Other preservatives can be added if desired, such as parabens, imidurea, and the like.

With respect to component v) (water), preferred are compositions in which the quantity of water is in the range of from 60 to 95% by weight, more preferably from 70 to 95% by weight, and most preferably from 60 to 93% by weight.

Compositions of the invention can be prepared by adding components i), ii) and iii) to component v) at room temperature with mixing. Then component iv) is added with mixing, followed by optional components vi) and vii) if needed or desired. The pH of the mixture is preferably 7±0.5.

The invention will be illustrated but not limited by the following examples.

### EXAMPLES

### Example 1

The following composition was prepared:

| Component | % by weight |
|---|---|
| Distilled water | 84.25 |
| Benzyl alcohol, NF | 5.00 |
| Mineral oil, NF | 5.00 |
| Sorbitan monooleate, NF | 2.50 |
| Polysorbate 80, NF | 2.50 |
| CARBOPOL ® 934 p, NF | 0.25 |
| Trolamine ™, NF* | 0.50 |
| | 100.00 |

*triethanolamine - added in the quantity shown or until a pH of 7.0 ± 0.5 is obtained.

The above composition was prepared by adding the distilled water, benzyl alcohol, mineral oil, sorbitan monooleate, and polysorbate 80 to a mixing vessel. Mixing was carried out for fifteen minutes. A white emulsion resulted. The speed of the mixer was then increased to form a vortex. The CARBOPOL® was added slowly to maintain a good dispersion Mixing was continued by an additional thirty minutes. The Trolamine was added slowly until a pH of 7.0±0.5 was obtained. The mixture formed a gel and mixing was slowed to minimize air entrapment. The final composition was in the form of a firm white lotion.

### Example 2

The following composition was prepared:

| Component | % by weight |
|---|---|
| Distilled water | 88.25 |
| Benzyl alcohol, NF | 5.00 |
| Mineral oil, NF | 5.00 |
| TRITON ® 940, NF | 1.00 |
| CARBOPOL ® 940, NF | 0.25 |
| Trolamine*, NF | 0.50 |
| | 100.00 |

*triethanolamine - added in the quantity shown or until a pH of 7 ± 0.5 is obtained.

The above composition was prepared by adding the benzyl alcohol, mineral oil and TRITON® GC-110 to the distilled water with mixing. Then the CARBOPOL® 940 was added with vigorous mixing for 30 minutes. Trolamine was added slowly with slow mixing until a pH of 7±0.5 was obtained. The mixture was in the form of a gel. Slow mixing was continued until the gel was uniform to minimize air entrapment.

### Example 3

The following composition was prepared:

| Component | % by weight |
|---|---|
| Distilled water | 88.25 |
| Benzyl alcohol, NF | 5.00 |
| Mineral oil, NF | 5.00 |
| TRITON ® GC-110 | 1.00 |
| CARBOPOL ® 940, NF | 0.25 |
| Trolamine*, NF | 0.50 |
| Methylparaben, NF | 0.15 |
| Propylparaben, NF | 0.05 |
| Imidurea, NF | 0.20 |
| | 100.00 |

*triethanolamine - added in the quantity shown or until a pH of 7 ± 0.5 is obtained.

The above composition was prepared by heating the distilled water to 70° C. and adding the methylparaben, propylparaben and imidurea with mixing until the solids dissolved. The mixture was cooled to room temperature. Then the benzyl alcohol, mineral oil and TRITON® GC-110 were added with mixing. The CARBOPOL® 940 was added with vigorous mixing for 30 minutes. Trolamine was added slowly with slow mixing until a pH of 7.0±0.5 was obtained. The mixture was in the form of a gel Slow mixing was continued until the gel was uniform to minimize air entrapment.

### Example 4

The composition of Example 2 was prepared, to which is then added with mixing 10% by weight, based on the weight of the composition, of 1% by weight of a combination of oxidoreductase, transferase, lyase, hydrolase, isomerase, and ligase in 9% by weight of water.

### Example 5

The following compositions were prepared:

| | |
|---|---|
| Component | % by weight |

| | | |
|---|---|---|
| Distilled water | 88.25 | 88.25 |
| Benzyl Alcohol, NF | 5.00 | 5.00 |
| Mineral Oil, NF | 5.00 | 5.00 |
| TRITON ® GC-110 | 1.00 | N/A |
| Polysorbate 80, NF (TWEEN ® 80) | N/A | 0.60 |
| Sorbitan Monooleate, NF (SPAN ® 80) | N/A | 0.40 |
| Carbomer 940, NF | 0.25 | N/A |
| Carbomer 934P, NF | N/A | 0.25 |
| Trolamine, NF* | 0.50 | 0.50 |
| | 100.0 | 100.00 |

*or sufficient to provide for pH of 7.0

The above compositions were prepared by adding the benzyl alcohol, mineral oil, and TRITON®GC-110 or Polysorbate 80, NF and Sorbitan monooleate, NF to the distilled water with mixing. Then the Carbomer 940, NF or Carbomer 934P, NF was added with vigorous mixing for 30 minutes. Trolamine was added slowly with slow mixing until a pH of 7.0±0.5 was obtained. The mixtures were in the form of a gel. Slow mixing was continued until the gel was uniform to minimize air entrapment.

The above compositions were formulated to provide rapid water rinse-off.

### Example 6

The following composition was prepared:

| Component | % by weight |
|---|---|
| Distilled water | 93.25 |
| Benzyl alcohol, NF | 5.00 |
| Polysorbate 80, NF (TWEEN ® 80) | 0.60 |
| Sorbitan Monooleate, NF (SPAN ® 80) | 0.80 |
| Carbomer 934P, NF | 0.25 |
| Trolamine, NF* | 0.50 |
| | 100.00 |

*or sufficient to provide for pH of 7.0

The above composition was prepared by adding the benzyl alcohol, Polysorbate 80, NF and Sorbitan monooleate, NF to the distilled water with mixing. Then the Carbomer 934P, NF was added with vigorous mixing for 30 minutes. Trolamine was added slowly with slow mixing until a pH of 7.0±0.5 was obtained. Slow mixing was continued until the composition was uniform to minimize air entrapment.

### Example 7

The following composition was prepared:

| Component | quantity, g | % by weight |
|---|---|---|
| Distilled water | 792.5 | 79.25 |
| Benzyl alcohol, NF | 100.0 | 10.0 |
| Mineral oil, 5 lt., NF | 50.0 | 5.0 |
| Sorbitan monooleate, NF (SPAN ® 80) | 25.0 | 2.50 |
| Polysorbate 80, NF (TWEEN ® 80) | 25.0 | 2.50 |
| Carbomer 934P, NF (CARBOPOL ® 934p) | 2.5 | 0.25 |
| Triethanolamine, NF | 5.0 | 0.50* |
| | 1000.00 | 100.00 |

*or quantity needed to obtain pH 7.0

The above composition was prepared by adding the first five components to a mixer in the order shown in the table. A white emulsion was obtained. The emulsion was stirred for 15 minutes. Then the mixer speed was increased to form a vortex, and the Carbomer 934P was added slowly to give a good dispersion, and the dispersion was stirred for an additional 30 minutes. Triethanolamine was added to obtain a pH of 7.0±0.5. The mixture gelled, followed by a slow stirring to minimize air entrapment. A very smooth uniform gel was obtained.

### Example 8

The following composition was prepared:

| Component | quantity, kg | % by weight |
|---|---|---|
| Distilled water | 742.5 | 74.25 |
| Benzyl alcohol, NF | 150.0 | 15.00 |
| Mineral oil, 5 lt., NF | 50.0 | 5.00 |
| Sorbitan monooleate, NF (SPAN ® 80) | 25.0 | 2.50 |
| Polysorbate 80, NF (TWEEN ® 80) | 25.0 | 2.50 |
| Carbomer 934P, NF (CARBOPOL ® 934P) | 2.5 | 0.25 |
| Triethanolamine, NF | 5.0 | 0.50* |
| | 1000.0 | 100.00 |

*or quantity needed to obtain pH 7.0

The above composition was prepared according to the process of Example 7.

The resulting composition was in the form of a smooth, uniform gel.

### Example 9

The following composition was prepared:

| Component | quantity, g | % by weight |
|---|---|---|
| Distilled water | 692.5 | 69.25 |
| Benzyl alcohol, NF | 200.0 | 20.00 |
| Mineral oil, 5 lt., NF | 50.0 | 5.00 |
| Sorbitan monooleate, NF (SPAN ® 80) | 25.0 | 2.50 |
| Polysorbate 80, NF (TWEEN ® 80) | 25.0 | 2.50 |
| Carbomer 934P, NF (CARBOPOL ® 934p) | 2.5 | 0.25 |
| Triethanolamine, NF | 5.0 | 0.50* |
| | 1000.0 | 100.00 |

*or quantity need to obtain pH 7.0

The above composition was prepared according to the process of Example 7.

The resulting composition was in the form of a gel, which was, however not completely uniform

### Example 10

The following composition is prepared:

| Component | Quantity, g | % by weight |
|---|---|---|
| Distilled water | 592.5 | 59.25 |
| Benzyl alcohol, NF | 300.0 | 30.00 |
| Mineral oil, 5 lt., NF | 50.0 | 5.00 |
| Sorbitan monooleate, NF (SPAN ® 80) | 25.0 | 2.50 |
| Polysorbate 80, NF (TWEEN ® 80) | 25.0 | 2.50 |
| Carbomer 934P, NF (CARBOPOL ® 934P) | 2.5 | 0.25 |
| Triethanolamine, NF | 5.0 | 0.50* |
| | 1000.00 | 100.00 |

*or quantity needed to obtain pH 7.0

The above composition is prepared according to the process of Example 7.

The resulting product is in the form of a liquid rather than in gel form.

### Example 11

The following composition is prepared by the procedure of Example 1.

| Component | % by weight |
|---|---|
| Distilled water | 85.25 |
| Benzyl alcohol, NF | 4.00 |
| Mineral oil, NF | 5.00 |
| Sorbitan, monooleate, NF | 2.50 |
| Polysorbate 80 NF | 2.50 |
| CARBOPOL ® 934P, NF | 0.25 |
| Trolamine, NF* | 0.50 |
| | 100.00 |

*triethanolamine added in the quantity shown or until a pH of 7.0 ± 0.5 is obtained.

### Example 12

The composition of Example 11 is prepared except that the % by weight of benzyl alcohol is 3.00% and the % by weight of water is 86.25%.

### Example 13

The composition of Example 11 is prepared except that the % by weight of benzyl alcohol is 2.00% and the % by weight of water is 87.25%.

### Example 14

The composition of Example 11 is prepared except that the % by weight of benzyl alcohol is 1.00% and the % by weight of water is 88.25%.

### Example 15

The composition of Example 1 was evaluated clinically according to the following protocol: An evaluator-masked, comparative, parallel, single-site, randomized study was carried out on 44 subjects (both males and females) between 2 and 70 years of age with an active infestation of Pediculus capitis, the human head louse, with at least 3 live lice and 10 viable eggs.

The subjects were randomly assigned to one of two treatment groups. In one group the subjects topically applied enough of the composition of Example 1 to completely saturate all of their hair (adjusted for each patient's hair length) and their scalp, and the composition was left in place for 10 minutes and then rinsed off with water. In the second group the composition of Example 1 was also topically applied to completely saturate all of their hair (adjusted for each patient's hair length) and their scalp, and the composition was left in place for 30 minutes and then rinsed off with water.

Pediculicidal activity was assessed by the presence or absence of live lice: 1) immediately after the first treatment (Day 1),2) at Day 8 (±1 day) and 3) at Day 15 (±2 days) after the first treatment.

At the Day 8 follow up, a second treatment was performed as set forth above, except that the second treatment was not performed if there were no live lice and nymphs present.

The primary efficacy variable was the % of subjects who were confirmed as treatment sucesses on day 15 based on the pediculicidal efficacy measured by the presence or absence of live lice. Since the primary efficacy outcome was a dichotomous variable (Treatment Success, yes/no), differences among treatment groups were asssessed using Fisher's Exact Tests.

The secondary efficacy variables (the number of lice, nymphs, and nits, and the kill rate, and kill rate by baseline characteristic (age, gender, race, disease severity and hair length)), for dichotomous measures, comparable analyses were performed as described above. For continuous measures, such as the number of lice, comparisons were made using analysis of variance (ANOVA).

Kill rate (%) was calculated by using the ratio of the number of dead lice over the total number of lice. Subgroup analyses based on the baseline characteristics, hair curliness, hair length and baseline disease severity were also performed for the kill rate using Fisher's Exact Tests.

All variables were assessed at the 0.05 alpha level (two-sided).

At the Day 1 pre-treatment evaluation, subjects in both the 10-minute and 30-minute application treatment group had lice and nits present. Greater than 50% of the subjects had severe infestations. At the Day 1 post-tea ment evaluation, the majority of subjects had all stages of lice present. The mean number of dead lice was 24.6 and 21.0 (p=0.655) and the mean number of live lice was 0.3 and 0.1 (p=0.342) respectively for the 10-minute and 30-minute applications.

At the day 8 pre-treatment evaluation, subjects in both the 10-minute and 30-minute application treatment groups had lice and nits present. At the Day 8 post-treatment evaluation, approximately 40% of subjects in both treatment groups had no lice present. The mean number of dead lice was decreased to 2.2 and 3.0, (p=0.625) and the mean number of live lice was also decreased to near zero (0.0±0.2 vs. 0.0±0.2, p=0.974) respective to the 10-minute and 30-minute applications.

On Day 15, six subjects in the 10-minute treatment group and two in the 30-minute treatment group were thought to have lice present based on the pre-shampoo visual inspection with a 5× magnifier light. At the post-shampoo evaluation with a 10× loop magnifier and halogen field light, no subjects were found to have live lice. One subject in the 30-minute application group had a dead nymph, believed to be left over from the Day 8 treatment. Lice seen on visual inspection were determined to be dead nymphs or molts that became non-discernable debris after shampooing.

Kill rate (%) was calculated by using the ratio of the number of dead lice over the total number of lice. There were no statistically significant differences in the kill rate between the 10-minute and 30-minute applications. At the Day 8 post treatment, the composition of Example 1 demonstrated >99% kill rates for both the 10-minute and 30-minute applications.

With respect to primary efficacy, there were no statistically significant differences in the overall treatment outcome for all three visits between the 10 minute and 30 minute applications. At the end of the study, the composition of Example 1 provided 100% overall success for both the 10 minute and 30 minute applications.

In addition, there were no treatment-related adverse events for any of the subjects in the study, i.e. the treatment was both safe and effective.

Moreover, kill rates for both the 10 minute and 30 minute applications were greater than 99% observed at Day 8 post treatment evaluation.

### Example 16

The composition of Example 2 was evaluated clinically, according to the following protocol:

After informed consent was obtained, twenty participants were enrolled in the study. Nineteen subjects completed all visits. One subject was dropped from the study after her mother shaved her head due to the “no nit policy” at the child's school.

Prior to treatment (Day 1), participants were visually evaluated for the number of viable lice and nits prior to treatment. A timed ten-minute application of the study product was then applied to thoroughly saturate the subject's hair (1-2 bottles depending on length). Immediately afterwards, the hair was rinsed with water, shampooed, rinsed and combed (with a wide-toothed comb). The rinse water was strained through a flour sack, cotton kitchen towel to collect and count the number of live or dead lice and nymphs present after the procedure.

One week later (Day 8), the above procedures were repeated for each subject.

Therefore, each subject had two, ten-minute treatments one week apart in order to kill any nymphs that might have hatched after treatment.

A final evaluation was conducted on Day 15 through visual inspection Nit removal was not conducted during the two-week study period. There were no adverse experiences (AE), and subject comments reflected satisfaction with regard to safety, efficacy and cosmetic acceptability.

There were a total of 20 females enrolled in the study. Most were heavily infested, some with hundreds of lice. Participants ranged from 5 to 35 year of age and had a mean age of 11.55 years (19 years). The mean height for all participants was 128.93 cm (±20.97 cm). The mean weight from all participants was 88.61 lbs (±42.3 lbs). See Table 1 below.

TABLE 1
Demographic Profile

| Age | Mean | | Mean | Std. Dev. | Mean | Std. Dev. |
|---|---|---|---|---|---|---|
| Range | Age | Std. Dev. | Height | Of | Weight | Of |
| (years) | (years) | Of Ages | (cm) | Heights | (lbs.) | Weights |
| 5 to 35 | 11.55 | ±8.19 | 128.93 | ±20.97 | 88.61 | ±42.3 |

Methods

The protocol and informed consent was approved by the Southern IRB, Miami, Fla. The study was conducted at Lice Source Services from October 4-25, 2001. Informed consent was obtained from subjects or their parents/guardians prior to enrollment. Participation was voluntary. Subject eligibility was determined by the presence of at least 5 live lice detected by visual inspection. Family members were included if they fit the eligibility criteria. This was an open-label pilot study, and all paints received the same treatment. See Tables 2 and 3 for baseline data.

The Lice Source Service investigation team administered all treatments Safety was evaluated by a scalp examination conducted before initial treatment and immediately after each treatment.

Pediculicidal efficacy was determined by the absence of live lice on day 8 (±1 day) and day 15±2 days) after initial treatment. After the first and second treatments, the rise water was collected and strained through a flour-sack kitchen towel. The towels were examined for any lice using a 6× lighted magnifier. If the subject had no live lice at the end of the study (day 15) they were scored as a TREATMENT SUCCESS.

The shampoo, comb, rinse, and sag method has been found to be more accurate in detecting lice than visual inspection. The number of lice and nymphs and their viability was recorded on the CRF.

TABLE 2
Severity of Infestations of Subjects at Baseline

| Severity | Lice* | Nits** |
|---|---|---|
| Mild | 5 | 0 |
| Moderate | 5 | 2 |
| Severe | 9 | 17 |
| Total | 19 | 19 |

*Lice: <10 = Mild; 10-15 = Moderate; >15 = Severe
**Nits: <10 = Mild; 11-19 = Moderate; 20-100's = Severe

TABLE 3
Stages of Lice in Subjects at Baseline

| | All |
|---|---|
| Adults Only | 1 |
| Nymphs Only | 0 |
| All Stages | 18 |
| Total | 19 |

Results

As per the study protocol, pediculcidal activity was assessed at Day 8. Eighteen subjects had no live lice at Day 8. The other remaining subject had one live nymph, indicating that the product appears to have excellent ovicidal activity All study participants were evaluated at Day 8, and were given a second treatment regardless of whether or not they had live lice. At the final follow up (Day 15), each participant was determined to be a treatment success. See Table 4 below.

TABLE 4
Treatment Success Rates of the Composition of Example 1

| Total # of completed | Rx Success at Day 15 | % Rx Success at Day 15 |
|---|---|---|
| 19 | 19 | 100% |

Conclusions

This open label pilot study in a population heavily infested with Pediculus capitis demonstrates that two treatments of 10 minutes each of the composition of Example 1 was 100% effective. The product had excellent cosmetic acceptability by the LSS Staff and the participants since it had no odor, was easy to use, and left the hair shiny and manageable.

### Example 17

The compositions of Example 5 (second formulation) and 6 were tested for their ability to kill nits (the nits of head lice). The nits were treated in vitro for 10 minutes, and compared to nits tated in vitro with plain water as a control. The results obtained are set forth in Table 5 below.

TABLE 5
Ovicidal date for head lice nits

| | No. of nits | No. of nits not | No. of nits | No. of nits |
|---|---|---|---|---|
| Composition | tested | hatched | stillborn | hatched |
| control (water) | 10 | 0 | 1 | 9 |
| Ex. 5 | 10 | 6 | 2 | 2 |
| Ex. 6 | 10 | 6 | 2 | 2 |
| control (water) | 10 | 1 | 1 | 8 |
| Ex. 5 | 10 | 10 | 0 | 0 |
| Ex. 5 | 9 | 9 | 0 | 0 |
| Ex. 5 | 10 | 10 | 0 | 0 |
| Ex. 6 | 10 | 10 | 0 | 0 |
| Ex. 6 | 9 | 9 | 0 | 0 |

In the above table, there were 20 controls, from which 17 nits hatched, i.e. a hatch rate of 85% (17÷20). With respect to the Example 5-composition, from 39 nits only 2 hatched, i.e. a hatch rate of 5.1%. With respect to the Example 6 composition, from 29 nits only 2 hatched, i.e. a hatch rate of 6.9%.

The ovicidal activity is calculated by dividing the number of nits that did not hatch plus those that were stillborn by the number tested. For the control the ovicidal activity was 15%. For the composition of Example 5 (second formulation), the ovicidal activity was 94.9%. For the composition of Example 6, the ovicidal activity was 93.1%.

### Example 18

When the composition of Examples 11, 12, 13, and 14 are applied to human subjects having head lice infestations according to the procedure of Example 15, a statistically significant kill of the head lice is obtained after the two applications (Day 15).

### Example 19

When the composition of Example 1 is applied to human subjects having head lice infestations according to the procedure of Example 15 except that treatment times of 2, 3, 5 and 9 minutes are employed for different groups of subjects, a statistically significant kill of the head lice is obtained for each group after the two applications (Day 15).

1. Method for topical treatment of ectoparasites, their nymphs, and their eggs, on mammalian skin and hair comprising the steps of:
A) applying a water soluble or water-dispersible, pharmacologically acceptable composition containing at least one pesticidally-active monohydric aralkyl alcohol to areas of mammal skin and hair infected with ectoparasites wherein
a) the composition contains a quantity in the range of from about 1 to about 50% by weight of the at least one monohydric aralkyl alcohol sufficient to provide pesticidal activity against the ectoparasites, their nymphs, and their eggs,
b) the composition is formulated so that when applied to the ectoparasites the composition prevents them from obtaining air through their breathing apparatuses,
c) the composition is applied to the infected areas in a quantity sufficient to completely saturate both the hair and skin in the infected areas, and
d) the composition can be readily washed out of the infected areas by rinsing with water;
B) leaving the composition in contact with the skin and hair in the infected area until at least most of the ectoparasites, nymphs and eggs have been killed; and
C) removing the composition and the dead ectoparasites, nymphs and eggs from the skin and hair with water or other aqueous based liquid.

2. The method of claim 1 wherein in step A) said composition is a substantially air-impermeable composition.

3. The method of claim 1 wherein in step B) the composition is left in contact with the skin and hair for a period of at least about 2 minutes.

4. The method of claim 3 wherein the composition is left in contact with the skin and hair for a period of at least about 3 minutes.

5. The method of claim 3 wherein the composition is left in contact with the skin and hair for a period of at least about 5 minutes.

6. The method of claim 3 wherein the period is from about 2 minutes to about 10 minutes.

7. The method of claim 3 wherein the composition is left in contact with the skin and hair for a period of from about 3 minutes to about 9 minutes.

8. The method of claim 1 wherein in step A) the at least one monohydric aralkyl alcohol has the formula: 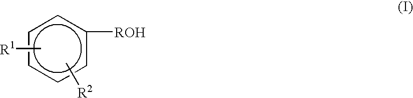
wherein R is a C₁-C₁₂ straight or branched chain, saturated or olefinically unsaturated alkylene group, and R¹ and R² are independently selected from the group consisting of hydrogen, halogen, C₁-C₄ alkyl and C₁-C₄ alkoxy groups.

9. The method of claim 8 wherein in formula (I) R is a C₁-C₆ saturated alkylene group.

10. The method of claim 8 wherein the at least one monohydric aralkyl alcohol is benzyl alcohol.

11. The method of claim 1 wherein the mammal is a human being.

12. The method of claim 2 wherein the mammal is a human being.

13. The method of claim 1 wherein the composition is in the form of a water-containing gel.

14. The method of claim 1 wherein the ectoparasites are lice and in step B) at least most of the nits as well as most of the lice and their nymphs have been killed.

15. The method of claim 1 wherein the method steps are carried out once, and then again after a time interval.

16. The method of claim 15 wherein the time interval ranges from about 1 week
to about 3 weeks.

17. The method of claim 14 wherein the lice are head lice.

18. The method of claim 12 wherein step C) is carried out by rinsing with water.

19. The method of claim 1 wherein in the composition in step 1) the at least one monohydric aralkyl alcohol is the only effective pesticidal component of the composition.

20. The method of claim 12 wherein the composition in step A) also contains
at least one of the following additional components:
a film forming agent,
a surface active agent,
a gelling or thickening agent.

21. The method of claim 20 wherein the composition contains all of said additional components.

22. The method of claim 2 wherein the composition in step A) contains from about 20% by weight of the at least one monohydric aralkyl alcohol, based on the weight of the composition.

23. The method of claim 1 wherein the composition in step A) contains from about 2 to about 20% by weight of at least one monhydric aralkyl alcohol.

24. The method of claim 1 wherein the composition in step A) contains from about 2 to about 9% by weight of at least one monohydric aralkyl alcohol.

25. The method of claim 1 wherein the composition in step A) contains from about 3 to about 7% by weight of at least one monohydric aralkyl alcohol.

26. The method of claim 1 wherein the composition in step A) contains from about 4 to about 6% by weight of at least one monohydric aralkyl alcohol.

27. The method of claim 1 wherein the composition in step A) contains from about 1 to about 4% by weight of benzyl alcohol.

28. The method of claim 22 wherein the monohydric aralkyl alcohol is benzyl alcohol.

29. The method of claim 23 wherein the monohydric aralkyl alcohol is benzyl alcohol.

30. The method of claim 24 wherein the monohydric aralkyl alcohol is benzyl alcohol.

31. The method of claim 25 wherein the monohydric aralkyl alcohol is benzyl alcohol.

32. The method of claim 26 wherein the monohydric alcohol is benzyl alcohol.

33. The method of claim 1 wherein step C) is carried out for from about 1 to about 5 minutes.

34. The method of claim 1 wherein step C) is carried out for from about 1 to about 3 minutes.

35. The method of claim 1 wherein more than 95% of the ectoparasites are killed.

36. The method of claim 35 wherein more than 99% of the ectoparasites are killed.

37. (canceled)

38. (canceled)

39. The method of claim 1 in which component A) is present in a quantity sufficient to prevent a head louse from closing its spiracle and to provide pediculicdal activity against the head louse, its nymphs, and its nits.

40. The method of claim 14 wherein the pesticidally-active monohydric aralkyl alcohol is benzyl alcohol; in step B) the composition is left in contact with the skin and hair for a period of at least about 2 minutes; the lice are head lice; benzyl alcohol is the only effective pesticidal component of the composition in step A); and the mammal is a human being.

41. The method of claim 40 wherein in step B) the composition is left in contact with the skin and hair for at least about 5 minutes; and the composition in step A) also contains at least one of a film forming agent, a surface active agent, and a gelling or thickening agent.

42. The method of claim 41 wherein the composition in step A) contains from

43. The method of claim 40 wherein the method steps are carried out once, and then again after a time interval.

44. The method of claim 43 wherein the time interval ranges from about 1 week to about 3 weeks.
